(19) United States
(12) Patent Application Publication
(10) Pub. No.: US 2023/0168389 A1
(43) Pub. Date: Jun. 1, 2023

(54) INFORMATION PROCESSING DEVICE AND INFORMATION PROCESSING METHOD

(71) Applicant: SONY GROUP CORPORATION, TOKYO (JP)

(72) Inventors: FUTOSHI TAKEUCHI, TOKYO (JP); HARUTO TAKEDA, TOKYO (JP); HIROYUKI KAMATA, TOKYO (JP); KOSEI YAMASHITA, TOKYO (JP)

(21) Appl. No.: 17/998,054

(22) PCT Filed: Apr. 30, 2021
(86) PCT No.: PCT/JP2021/017147

§ 371 Date: Nov. 7, 2022

(30) Foreign Application Priority Data
May 15, 2020 (JP) 2020-085919

(51) Int. Cl. G01S 19/54; G01S 19/03

(52) U.S. Cl. CPC G01S 19/54; G01S 19/03

(57) ABSTRACT

The present disclosure relates to an information processing device and an information processing method capable of realizing attitude estimation more suitably.

A reception control unit controls a plurality of antennas such that the antennas switch and receive positioning signals from positioning satellites in a time division manner, and an attitude estimation unit estimates an attitude of an object on the basis of phase differences between carrier phases of the positioning signals received by the plurality of antennas. The technology according to the present disclosure can be applied to, for example, a reception device mounted on an artificial satellite.

### TECHNICAL FIELD

The present disclosure relates to an information processing device and an information processing method, and more particularly, to an information processing device and an information processing method capable of realizing attitude estimation more suitably.

### BACKGROUND ART

In recent years, a lot of technologies for estimating the attitudes of moving objects such as artificial satellites and drones have been proposed.

For example, PTL 1 discloses an attitude angle calculation device that rotates a positioning antenna installed on a rod-shaped rotating body and calculates an attitude angle on the basis of a phase difference between carrier phases of positioning signals received at different times.

### CITATION LIST

### Patent Literature

[PTL 1]
JP 2018-59856 A

### SUMMARY

### Technical Problem

However, since the configuration of PTL 1 has a mechanical structure for rotating the positioning antenna, there are restrictions on the installation surface of the positioning antenna and positioning signal reception timing.

In view of such circumstances, an object of the present disclosure is to realize attitude estimation more suitably.

### Solution to Problem

An information processing device of the present disclosure is an information processing device including: a reception control unit configured to control a plurality of antennas such that the antennas switch and receive positioning signals from positioning satellites in a time division manner; and an attitude estimation unit configured to estimate an attitude of an object on the basis of phase differences between carrier phases of the positioning signals received by the plurality of antennas.

An information processing method of the present disclosure is an information processing method performed by an information processing device, including: controlling a plurality of antennas such that the antennas switch and receive positioning signals from positioning satellites in a time division manner; and estimating an attitude of an object on the basis of phase differences between carrier phases of the positioning signals received by the plurality of antennas.

In the present disclosure, a plurality of antennas are controlled such that they switch and receive positioning signals from positioning satellites in a time division manner, and an attitude of an object is estimated on the basis of phase differences between carrier phases of the positioning signals received by the plurality of antennas.

### BRIEF DESCRIPTION OF DRAWINGS

FIG. 1 is a diagram illustrating a conventional GNSS compass.

FIG. 2 is a diagram illustrating an overview of technology according to the present disclosure.

FIG. 3 is a block diagram showing a configuration example of a reception device of the present disclosure.

FIG. 4 is a flowchart illustrating a flow of attitude estimation processing.

FIG. 5 is a flowchart illustrating a flow of attitude estimation processing.

FIG. 6 is a diagram illustrating correction of a carrier phase.

FIG. 7 is a diagram illustrating an example of calculating a gradient of a baseline vector.

FIG. 8 is a block diagram showing another configuration example of a reception device.

FIG. 9 is a diagram illustrating calculation of a gradient of a baseline vector based on a rotational momentum.

FIG. 10 is a diagram illustrating attitude correction based on a rotational momentum.

FIG. 11 is a diagram illustrating antenna switching control.

FIG. 12 is a block diagram showing still another configuration example of a reception device.

FIG. 13 is a block diagram showing a configuration example of computer hardware.

### DESCRIPTION OF EMBODIMENTS

Hereinafter, modes for carrying out the present disclosure (hereinafter referred to as embodiments) will be described. The description will be made in the following order.

1. Overview of conventional technology and technology according to present disclosure
2. Configuration example of reception device
3. Flow of attitude estimation processing
4. Other configuration examples of reception device
5. Configuration example of computer

### 1. Overview of Conventional Technology and Technology According to Present Disclosure

An object of the technology according to the present disclosure is to estimate an absolute position and attitude of a moving object such as an artificial satellite or a drone.

Since environments in which artificial satellites and drones move are not environments in which a fixed gravitational acceleration is applied in a certain direction, it is impossible to estimate an absolute attitude by an inertial measurement unit (IMU) based on the center of gravity of the earth. For example, a constant gravitational acceleration is not applied due to the balance with the centrifugal force in a satellite orbit in which an artificial satellite moves, and a constant gravitational acceleration is not applied due to a sudden acceleration/deceleration of a drone in the air where the drone flies.

Meanwhile, a global navigation satellite system (GNSS) compass using a GNSS receiver such as a global positioning system (GPS) has been conventionally used for estimation of a traveling direction and attitude estimation in ships or space stations. In such a GNSS compass, a plurality of receivers are synchronized to receive positioning signals from a plurality of positioning satellites.

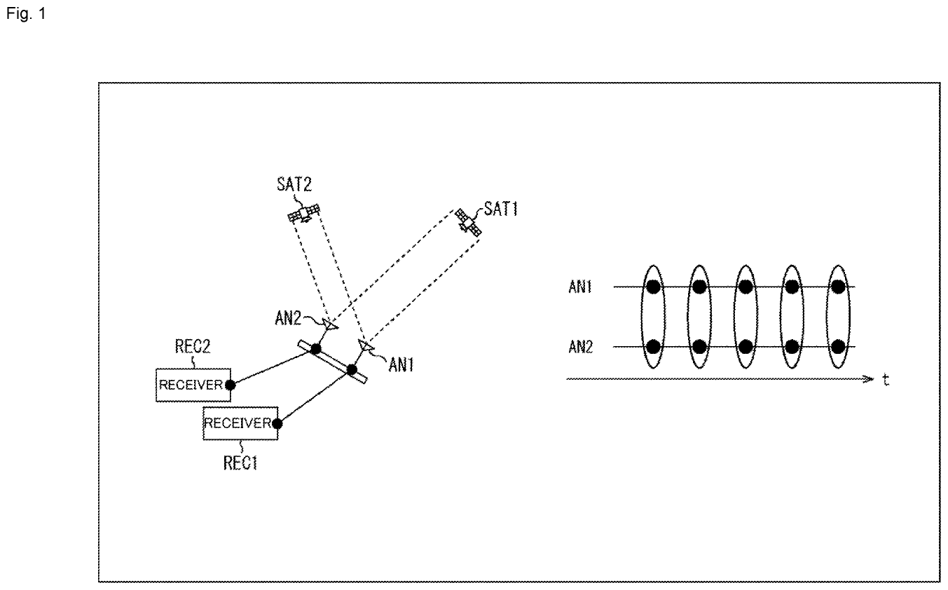

For example, as shown in the left figure of FIG. 1, when the positioning signals from the two positioning satellites SAT1 and SAT2 are received, the positioning signals from the positioning satellites are simultaneously received by two antennas AN1 and AN2. In receivers REC1 and REC2 corresponding to the antennas AN1 and AN2, attitude estimation is performed by measuring carrier phases of the positioning signals simultaneously received and comparing the measured carrier phases.

That is, in the conventional GNSS compass, as shown in the right figure of FIG. 1, relative positioning is performed based on the positioning signals simultaneously received by the two antennas AN1 and AN2 having a fixed relative distance.

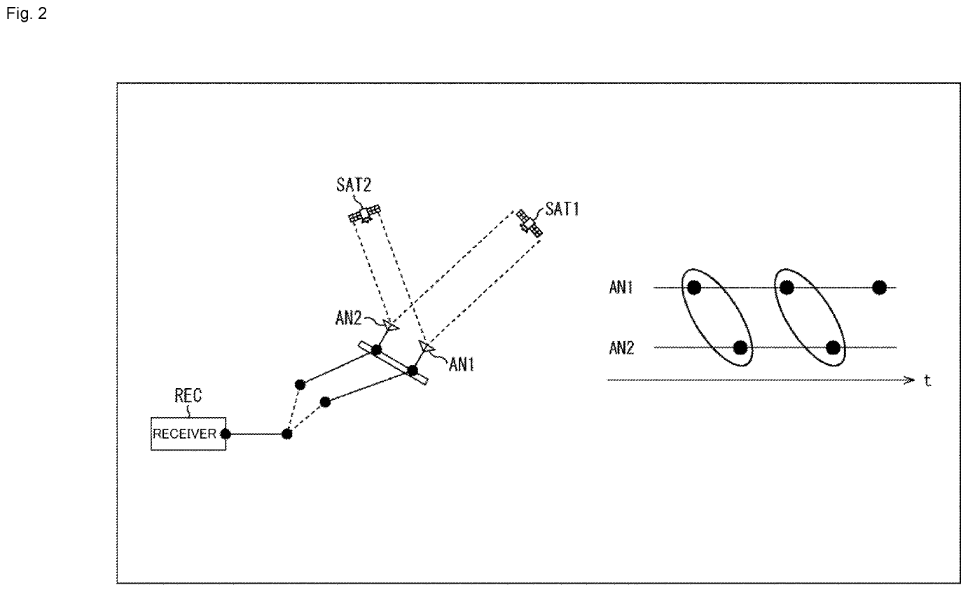

However, in the conventional GNSS compass, the cost of the entire device increases because it is necessary to provide a plurality of receivers for a plurality of antennas. Therefore, in a reception device to which the technology according to the present disclosure (the present technology) is applied, as shown in the left figure of FIG. 2, positioning signals from positioning satellites SAT1 and SAT2 are received by two antennas AN1 and AN2 in a time division manner. In a receiver REC that controls switching of reception by the antennas AN1 and AN2, attitude estimation is performed by correcting carrier phases of the positioning signals received in a time division manner and comparing the corrected carrier phases.

That is, in the reception device to which the present technology is applied, as shown in the right figure of FIG. 2, relative positioning is performed based on the positioning signals received by the two antennas AN1 and AN2 having a fixed relative distance with a time difference.

As described above, according to the present technology, it is possible to realize attitude estimation more suitably even in a configuration in which only one receiver is provided for a plurality of antennas.

In the following, a configuration and operation of a reception device which is a form of an information processing device to which the present technology is applied will be described.

### 2. Configuration Example of Reception Device

### (Configuration of Entire Reception Device)

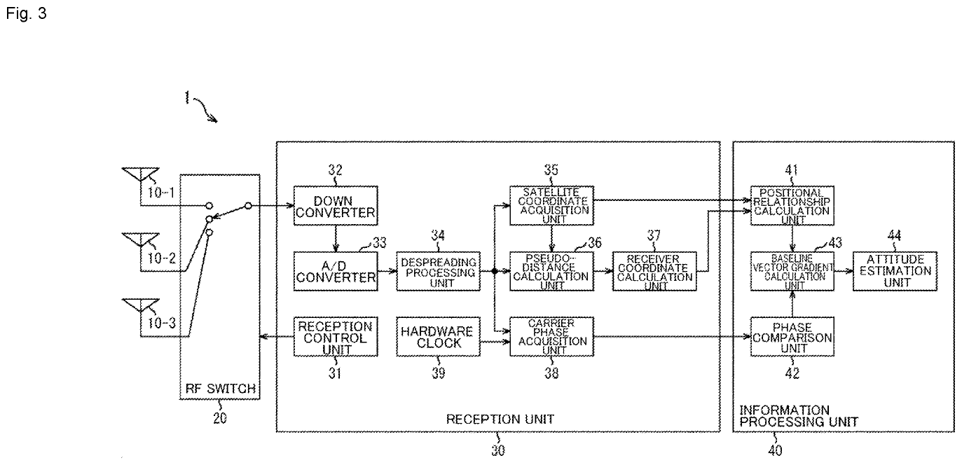

FIG. 3 is a block diagram showing a configuration example of a reception device to which the present technology is applied.

The reception device 1 shown in FIG. 3 is mounted on an object moving in a space, such as an artificial satellite or a drone, and estimates the attitude of the object. In the following, the reception device 1 will be described as being mounted on an artificial satellite.

The reception device 1 includes three antennas 10-1, 10-2, and 10-3, an RF switch 20, a reception unit 30, and an information processing unit 40.

The antennas 10-1, 10-2, and 10-3 are disposed on the surface of the housing of the reception device 1, for example, in an L shape. In order to perform attitude estimation, it is necessary to know the orientations of at least two axes, and thus three or more antennas are required. Therefore, the three antennas 10-1, 10-2, and 10-3 are shown in FIG. 3, but four or more antennas may be provided. Hereinafter, when the antennas 10-1, 10-2, and 10-3 are not distinguished from one another, they are simply referred to as an antenna 10.

The antenna 10 receives a positioning signal (RF signal) arriving from the positioning satellite and outputs the positioning signal to the reception unit 30 via the RF switch 20. The signal obtained from the antenna 10 is an analog signal and is regarded as a high frequency signal.

The RF switch 20 switches paths of positioning signals between the antennas 10-1, 10-2, and 10-3 and the reception unit 30 in a time division manner on the basis of control of the reception unit 30.

The reception unit 30 and the information processing unit 40 constitute the receiver REC shown in FIG. 2.

The reception unit 30 is configured as a GNSS reception IC, performs signal processing on a positioning signal from the antenna 10 by executing a predetermined program, and supplies obtained information to the information processing unit 40.

The information processing unit 40 is configured as a microprocessor, an application processor, or the like and estimates the attitude of the reception device 1 (artificial satellite) on the basis of the information from the reception unit 30 by executing a predetermined program.

Here, details of functional components realized by the reception unit 30 and the information processing unit 40 executing the programs will be described.

### (Details of Reception Unit)

The reception unit 30 includes a reception control unit 31, a down converter 32, an A/D converter 33, a despreading processing unit 34, a satellite coordinate acquisition unit 35, a pseudo-distance calculation unit 36, a receiver coordinate calculation unit 37, a carrier phase acquisition unit 38, and a hardware clock 39.

The reception control unit 31 controls the RF switch 20 such that the plurality of antennas 10 switch and receive a positioning signal from a positioning satellite in a time division manner. Although the reception control unit 31 is provided in the reception unit 30 in FIG. 3, it may be provided in the information processing unit 40.

The down converter 32 down-converts the positioning signal received by the antenna 10 into an IF signal and supplies the IF signal to the A/D converter 33.

The A/D converter 33 A/D-converts the IF signal from the down converter 32 and supplies the obtained positioning signal as a digital signal to the despreading processing unit 34.

The despreading processing unit 34 performs despreading using a spreading code corresponding to the captured positioning satellite on the positioning signal from the A/D converter 33. The despread positioning signal is supplied to the satellite coordinate acquisition unit 35, the pseudo-distance calculation unit 36, and the carrier phase acquisition unit 38. It is possible to acquire a navigation message with respect to the captured positioning satellite from the despread positioning signal. The navigation message includes orbit information (ephemeris) of the captured positioning satellite.

The satellite coordinate acquisition unit 35 acquires the coordinates (position information) of the captured positioning satellite from the positioning signal despread by the despreading processing unit 34 and supplies the coordinates to the pseudo-distance calculation unit 36 and the information processing unit 40.

The pseudo-distance calculation unit 36 calculates a pseudo-distance which is an apparent distance to the positioning satellite on the basis of the navigation message included in the positioning signal from the despreading processing unit 34 and the coordinates of the positioning satellite from the satellite coordinate acquisition unit 35. The calculated pseudo-distance is supplied to the receiver coordinate calculation unit 37.

The receiver coordinate calculation unit 37 calculates the coordinates of the receiver (reception device 1) on the basis of the pseudo-distance calculated by the pseudo-distance calculation unit 36 and supplies the coordinates to the information processing unit 40.

The carrier phase acquisition unit 38 acquires (measures) a carrier phase of the positioning signal from the captured positioning satellite from the positioning signal despread by the despreading processing unit 34 and supplies the carrier phase to the information processing unit 40. The carrier phase of the positioning signal is acquired for each captured positioning satellite. At this time, the carrier phase acquisition unit 38 adds clock information from the hardware clock 39 to information representing the carrier phase as time information indicating the timing at which the carrier phase is acquired and supplies the information to the information processing unit 40.

### (Details of Information Processing Unit)

The information processing unit 40 includes a positional relationship calculation unit 41, a phase comparison unit 42, a baseline vector gradient calculation unit 43, and an attitude estimation unit 44.

The positional relationship calculation unit 41 calculates a positional relationship between the captured positioning satellite and the receiver on the basis of the coordinates of the positioning satellite from the satellite coordinate acquisition unit 35 and the coordinates of the receiver from the receiver coordinate calculation unit 37 and supplies the positional relationship to the baseline vector gradient calculation unit 43. The positional relationship between the positioning satellite and the receiver is represented by, for example, an xyz orthogonal coordinate system with the center of the earth as the origin.

The phase comparison unit 42 corrects phase differences between the carrier phases of the positioning signals received by the plurality of antennas 10 by correcting and comparing the carrier phase of each positioning satellite from the carrier phase acquisition unit 38 and supplies the corrected phase differences to the baseline vector gradient calculation unit 43. Specifically, since the plurality of antennas 10 receive the positioning signals from each positioning satellite in a time division manner, the phase comparison unit 42 corrects the carrier phases of the positioning signals on the basis of time differences in the positioning signals between the antennas 10. The time differences in the positioning signals between the antennas 10 are calculated on the basis of time information when the carrier phases are acquired by the carrier phase acquisition unit 38.

The baseline vector gradient calculation unit 43 calculates gradients of baseline vectors between antennas 10 on the basis of the positional relationship between the positioning satellite and the receiver from the positional relationship calculation unit 41 and the phase differences between the carrier phases of the positioning signals from the phase comparison unit 42 and supplies the gradients of the baseline vectors to the attitude estimation unit 44.

The attitude estimation unit 44 estimates the attitude of the receiver (reception device 1) on the basis of the gradients of the baseline vectors between the antennas 10 from the baseline vector gradient calculation unit 43.

### 3. Flow of Attitude Estimation Processing

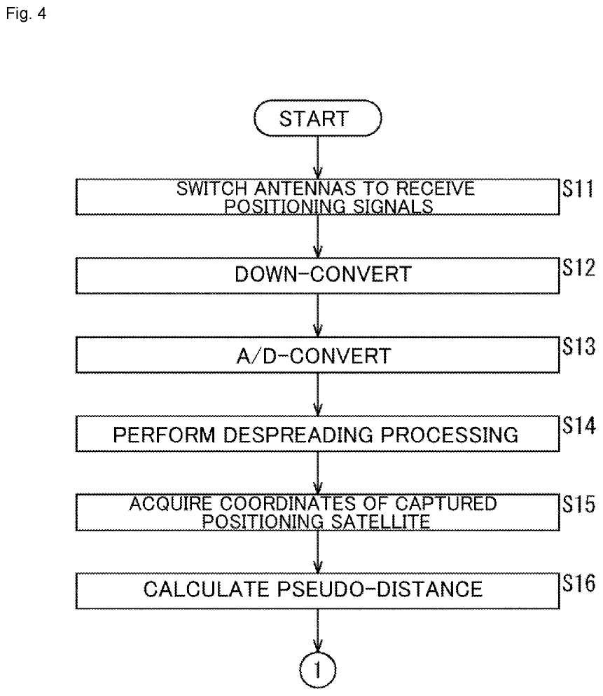

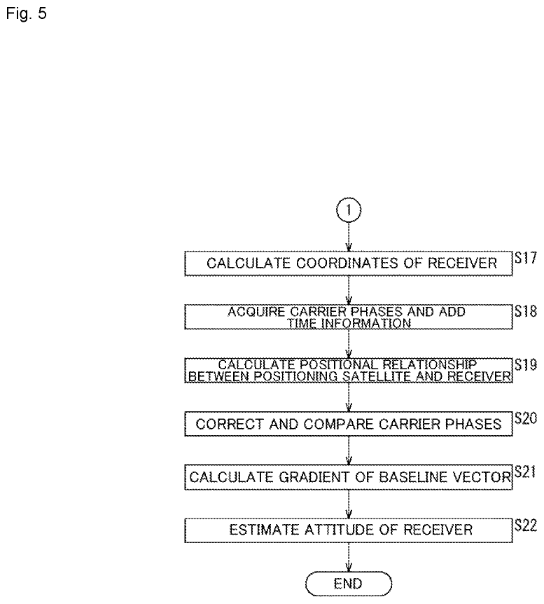

Next, a flow of attitude estimation processing performed by the receiver (reception device 1) will be described with reference to the flowcharts of FIG. 4 and FIG. 5. Processing of FIG. 4 and FIG. 5 is repeatedly executed at predetermined timings.

In step S11, the reception control unit 31 switches the antennas 10 to cause the antennas 10 to receive positioning signals by controlling the RF switch 20.

In step S12, the down converter 32 down-converts the positioning signals received by the antennas 10 into IF signals.

In step S13, the A/D converter 33 A/D-converts the IF signals down-converted by the down converter 32 to acquire positioning signals as digital signals.

In step S14, the despreading processing unit 34 performs despreading using a spreading code corresponding to a captured positioning satellite on the positioning signals A/D-converted by the A/D converter 33.

In step S15, the satellite coordinate acquisition unit 35 acquires the coordinates of the captured positioning satellite from the positioning signals despread by the despreading processing unit 34.

In step S16, the pseudo-distance calculation unit 36 calculates a pseudo-distance of the positioning satellite on the basis of the positioning signals despread by the despreading processing unit 34 and the coordinates of the positioning satellite acquired by the satellite coordinate acquisition unit 35. Thereafter, processing proceeds to step S17 of FIG. 5.

In step S17, the receiver coordinate calculation unit 37 calculates the coordinates of the receiver (reception device 1) on the basis of the pseudo-distance calculated by the pseudo-distance calculation unit 36.

In step S18, the carrier phase acquisition unit 38 acquires the carrier phases of the positioning signals from the captured positioning satellite from the positioning signals despread by the despreading processing unit 34. At this time, clock information from the hardware clock 39 is added to information representing the acquired carrier phases as time information representing the timing at which the carrier phases are acquired.

In step S19, the positional relationship calculation unit 41 calculates a positional relationship between the positioning satellite and the receiver on the basis of the coordinates of the positioning satellite acquired by the satellite coordinate acquisition unit 35 and the coordinates of the receiver calculated by the receiver coordinate calculation unit 37.

In step S20, the phase comparison unit 42 corrects and compares the carrier phases of the positioning signals received by the respective antennas 10 on the basis of the carrier phase of each positioning satellite acquired by the carrier phase acquisition unit 38.

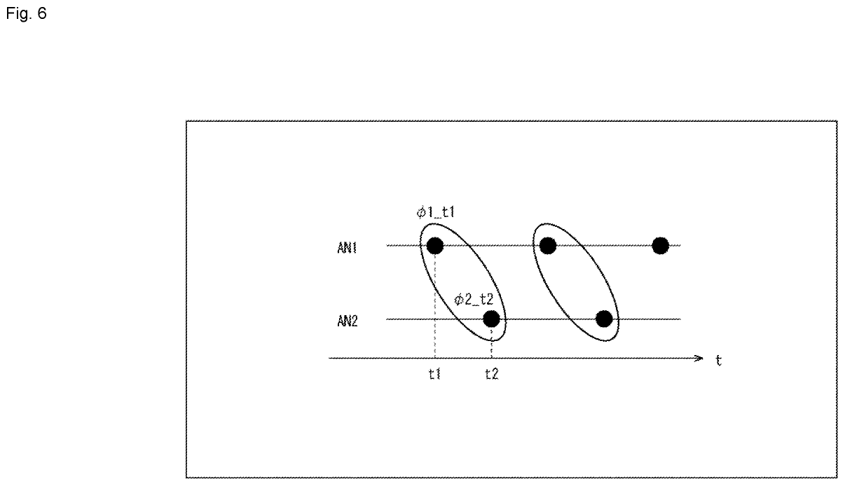

Here, a case in which positioning signals are received with a time difference by two antennas AN1 and AN2 having a fixed relative distance as shown in the right figure of FIG. 2 is considered. Specifically, as shown in FIG. 6, it is assumed that a positioning signal from a certain positioning satellite is received by the antenna AN1 at a time t1 and is received by the antenna AN2 at a time t2. In this example, it is assumed that the carrier phase of the positioning signal received by the antenna AN1 at the time t1 is φ1_t1, and the carrier phase of the positioning signal received by the antenna AN2 at the time t2 is φ2_t2.

When the time t2 is used as a reference, a phase difference Δφ_t2 of the carrier phase of the positioning signal at the time t2 can be obtained by estimating the carrier phase φ1_t2 of the positioning signal received by the antenna AN1 at the time t2.

Specifically, assuming that the positioning signal is received by the antenna AN1 at the time t2, the carrier phase φ1_t2 of the positioning signal is obtained by the following formula for correcting the carrier phase φ1_t1 at the time t1.

ϕ1_t2=ϕ1_t1+∫ₜ₁^{t2}ωt [Math. 1]

Accordingly, the phase difference Δφ_t2 between the carrier phases of the positioning signal assumed to be received by the antennas AN1 and AN2 at the time t2 can be obtained by the following formula.

Δϕ_t2=ϕ2_t2−ϕ1_t2 [Math. 2]

When phase differences of the carrier phases of the positioning signals between the antennas 10 are obtained in this way, processing proceeds to step S21. The phase differences in the carrier phases of the positioning signals between the antennas 10 are not limited to the above-mentioned formula and can be obtained by any method.

In step S21, the baseline vector gradient calculation unit 43 calculates gradients of baseline vectors between the antennas 10 on the basis of the positional relationship between the positioning satellite and the receiver calculated by the positional relationship calculation unit 41 and the phase differences between the carrier phases obtained by the phase comparison unit 42.

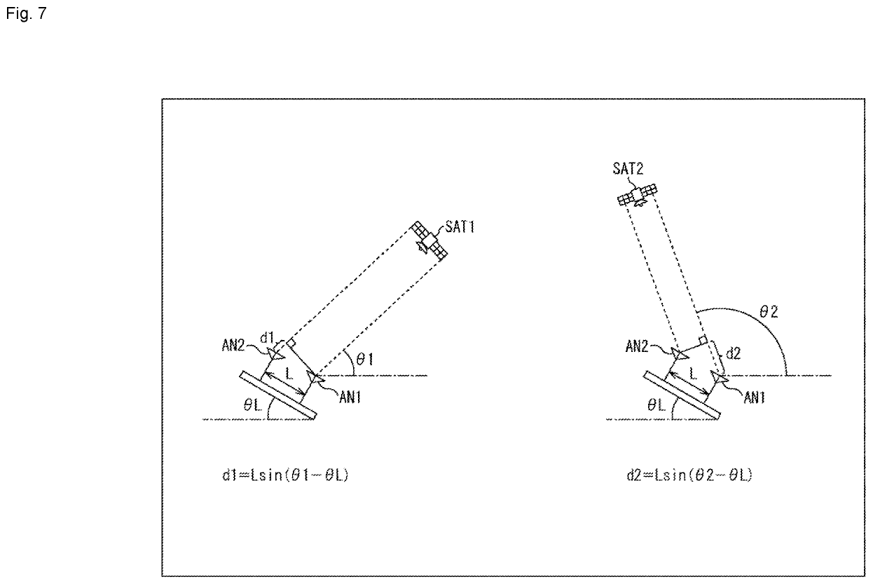

Here, although the gradients of the two baseline vectors orthogonal to each other in an L shape between the three antennas 10 are calculated, an example of calculating a gradient θL of a baseline vector between two antennas is described with reference to FIG. 7. It is assumed that the baseline vector (baseline length) L between the antennas AN1 and AN2 shown in FIG. 7 is known.

First, as shown in the left figure of FIG. 7, a path difference d1 in positioning signals from a positioning satellite SAT1 between the antennas AN1 and AN2 is obtained on the basis of a carrier phase difference between the antennas AN1 and AN2 and the wavelength of a carrier. Further, the angular direction θ1 of the positioning satellite SAT1 is obtained on the basis of the positional relationship between the positioning satellite and the receiver. Since the path difference d1 is represented by d1=L sin(θ1−θL), the gradient θL of the baseline vector L can be calculated.

Further, as shown in the right figure of FIG. 7, a path difference d2 in positioning signals from a positioning satellite SAT2 between the antennas AN1 and AN2 is also represented by d2=L sin(θ1−θL), and thus the gradient θL of the baseline vector L can be calculated in the same manner.

As described above, the gradient θL of the baseline vector L may be calculated by a so-called single phase difference, or the gradient θL of the baseline vector L may be calculated by a double phase difference that is a difference between the single phase difference with respect to the positioning satellite SAT1 and the single phase difference with respect to the positioning satellite SAT2.

Returning to the flowchart of FIG. 5, when the gradient of each baseline vector between the antennas 10 is calculated, processing proceeds to step S22.

In step S22, the attitude estimation unit 44 estimates the attitude of the receiver (reception device 1) on the basis of the gradient of each baseline vector calculated by the baseline vector gradient calculation unit 43.

According to the above-described processing, the attitude of an object can be estimated by switching and receiving positioning signals in a time division manner and correcting and comparing carrier phases in a configuration in which only one receiver is provided for a plurality of antennas.

That is, according to the present technology, it is not necessary to provide a plurality of receivers for a plurality of antennas, and thus the cost of the entire device can be reduced and the present technology can be applied to configurations in which the sizes of devices such as small satellites and drones are restricted.

For example, even when antennas are extended for more accurate attitude estimation, it is only necessary to increase the number of antennas and RF switches and there is no need to add a receiver, and thus reduction in the cost and power can be promoted.

Furthermore, antennas may be installed on each surface of the housing of a satellite when the attitude thereof is not determined (that is, a positional relationship with a positioning satellite is not determined), such as at the time when a small satellite is put into a satellite orbit. Even in such a case, antennas can be easily extended only by increasing the number of antennas and RF switches.

In addition, in a configuration having a mechanical structure for rotating a positioning antenna as disclosed in PTL 1 (JP 2018-59856 A), antenna installation surfaces are limited to the same plane. Further, in the configuration as in PTL 1, it is difficult to flexibly control a positioning signal reception timing because antennas are mechanically moved by rotation.

On the other hand, according to the present technology, antenna connection can be electrically switched, and thus an antenna installation surface can be determined with a high degree of freedom simply by increasing the number of connection wires.

In addition, reception of positioning signals can be rapidly switched by electrically switching antennas, and attitude estimation can be performed with a small error even while the attitude of an object is changing.

Further, in the configuration as in PTL 1, information is basically acquired by receiving signals in a fixed order and frequency determined in rotation in one direction. On the other hand, according to electrical switching of antennas as in the present technology, the order and frequency of signal reception can be adaptively adjusted according to priority of attitude angles to be estimated.

As described above, according to the present technology, it is possible to realize attitude estimation more suitably.

### 4. Other Configuration Examples of Reception Device

In the following, other configuration examples of the reception device to which the present technology is applied will be described.

(Component that Performs Attitude Estimation in Consideration of Rotational Movement of Object)

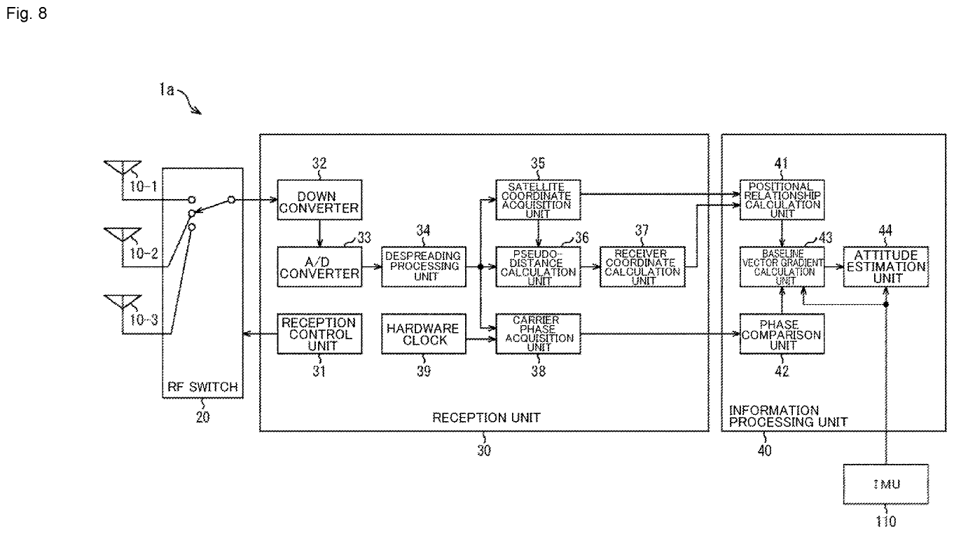

FIG. 8 is a block diagram showing another configuration example of a reception device to which the present technology is applied.

The reception device 1a shown in FIG. 8 is mounted on an object moving in a space, such as an artificial satellite or a drone, and estimates the attitude of the object. Further, the reception device 1a estimates the attitude of the object on the basis of the rotational momentum of the object measured by an IMU 110 mounted on the object in the same manner.

For example, when the reception device 1a is mounted on an artificial satellite, information on the amount rotated during sampling of carrier phases to be compared is reflected in phase differences and attitude estimation result in a state in which the artificial satellite itself is rotating.

Therefore, the attitude estimation unit 44 of the reception device 1a estimates the attitude of the object in consideration of attitude change based on the rotational momentum of the object measured by the IMU 110.

For example, the baseline vector gradient calculation unit 43 is configured to calculate gradients of baseline vectors on the basis of a positional relationship between a positioning satellite and a receiver, phase differences between carrier phases, and a rotational momentum corresponding to a time difference in positioning signal reception timing between the antennas 10, thereby estimating the attitude of an object in consideration of attitude change.

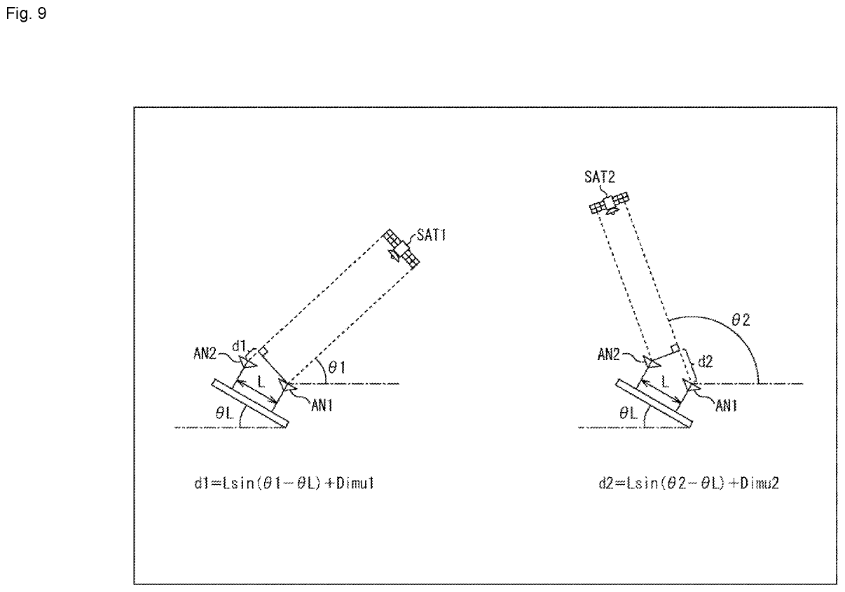

Specifically, as shown in the left figure of FIG. 9, the gradient θL of a baseline vector L is calculated by adding path difference variation Dimu1 estimated from a rotational momentum measured by the IMU 110 between a time t1 and a time t2 to a path difference d1 in positioning signals from a positioning satellite SAT1 between antennas AN1 and AN2.

Similarly, as shown in the right figure of FIG. 9, the gradient θL of a baseline vector L may be calculated by adding path difference variation Dimu2 estimated from a rotational momentum measured by the IMU 110 between the time t1 and the time t2 to a path difference d2 of positioning signals from a positioning satellite SAT2 between the antennas AN1 and AN2.

Further, the attitude estimation unit 44 may correct the estimated attitude of the object on the basis of a rotational momentum corresponding to a time difference in positioning signal reception timing between the antennas 10.

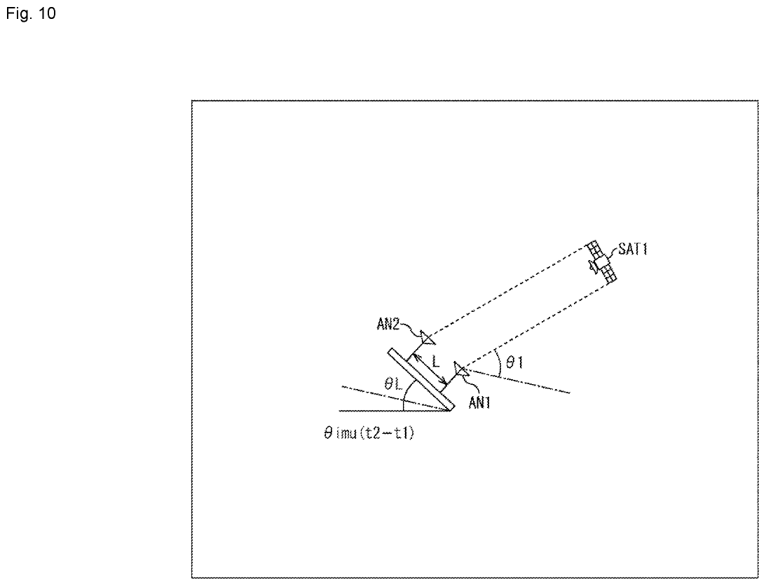

In this case, as shown in FIG. 10, the estimated attitude of the object is corrected by adding attitude variation θimu (t2−t1) estimated from the rotational momentum measured by the IMU 110 between the time t1 and the time t2 to the gradient θL of the baseline vector L calculated on the basis of the path difference d1, for example.

Meanwhile, correction of carrier phases described with reference to FIG. 9 and correction of the estimated attitude of the object described with reference to FIG. 10 may be performed in combination.

According to the above-described configuration, it is possible to realize attitude estimation more suitably even in a state in which an object is rotating.

### (Antenna Switching Control)

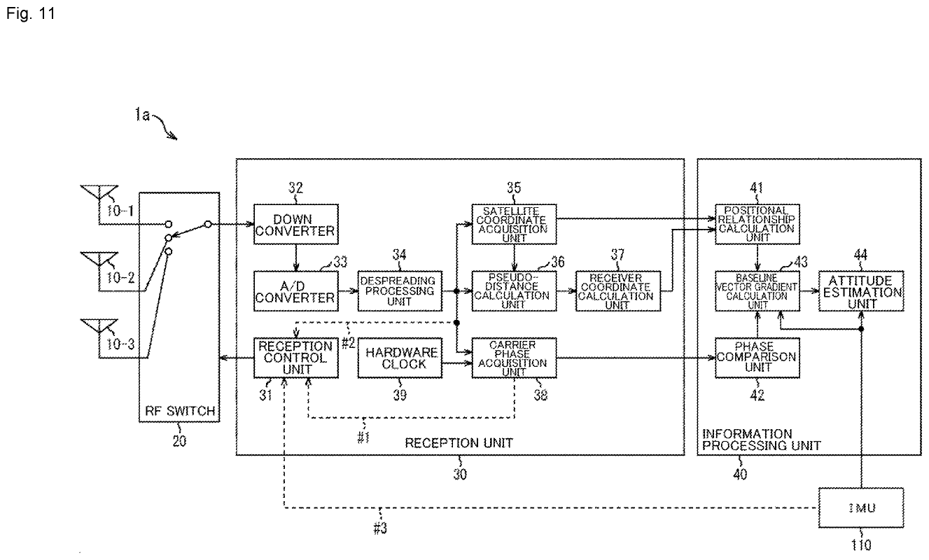

Next, antenna switching control in the reception device to which the present technology is applied will be described with reference to FIG. 11.

Although the reception device 1a of FIG. 8 is shown in FIG. 11 as an object of description, the reception device 1 of FIG. 3 may be the object of description.

As described above, the reception control unit 31 switches a plurality of antennas 10 in a time division manner by controlling the RF switch 20. In the following, a specific example of switching control of the antennas 10 by the reception control unit 31 will be described.

### Example 1

As indicated by arrow #1 in the figure, the reception control unit 31 controls switching of the antennas 10 such that the antennas 10 switch and receive positioning signals in a time division manner on the basis of a phase lock state of carrier phases of positioning signals from a captured positioning satellite, acquired by the carrier phase acquisition unit 38. Specifically, the reception control unit 31 performs switching to the next antenna 10 upon determining that information has been acquired from positioning signals in a stable captured state from the phase lock state of the carrier phases.

### Example 2

As indicated by arrow #2 in the figure, the reception control unit 31 controls switching of the antennas 10 such that the antennas 10 switch and receive positioning signals in a time division manner on the basis of the signal strength of positioning signals from the captured positioning satellite that have been despread by the despreading processing unit 34. Specifically, the reception control unit 31 controls the length of a switching cycle of the antennas 10 such that positioning signals having a stable signal strength are received on the basis of the signal strength of positioning signals. Accordingly, it is possible to balance the accuracy and frequency of attitude estimation.

### Example 3

As indicated by arrow #3 in the figure, the reception control unit 31 controls switching of the antennas 10 such that the antennas 10 switch and receive positioning signals in a time division manner in the order according to a rotation direction of the object measured by the IMU 110. Specifically, the reception control unit 31 controls the switching timing of the antennas 10 such that carrier phases with respect to the rotation direction of the object are compared more frequently. Accordingly, it is possible to maintain/improve the accuracy of attitude estimation according to the rotational movement of the object by comparing phase differences in a direction of fast rotation with high frequency and comparing phase differences in a direction of slow rotation with low frequency, and the like.

### (Configuration of Receiver as One Chip)

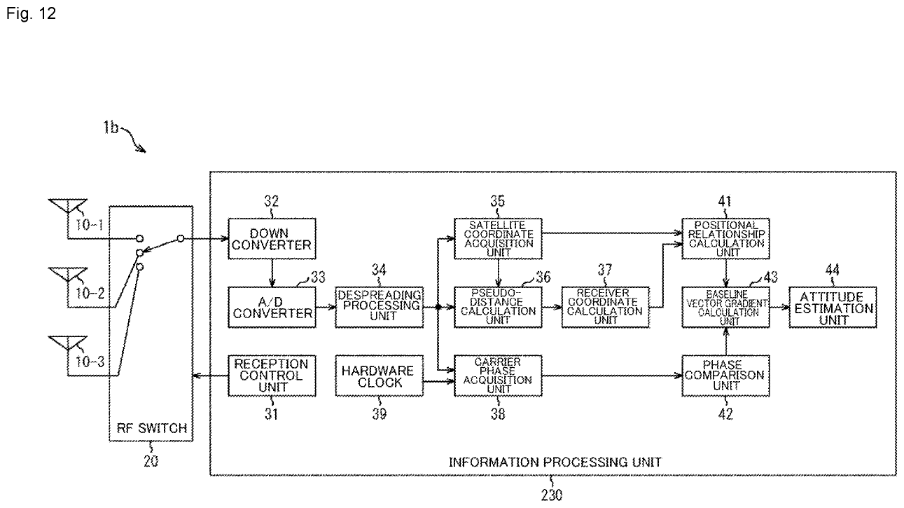

FIG. 12 is a block diagram showing further another configuration example of a reception device to which the present technology is applied. The reception device 1b shown in FIG. 12 differs from the reception device 1 of FIG. 1 and the reception device 1a of FIG. 8 described above in that it includes an information processing unit 230 in which the reception unit 30 and the information processing unit 40 constituting the receiver are integrated into one chip.

The information processing unit 230 is configured as, for example, a single board computer or the like, and realizes the same functional configuration as the reception unit 30 and the information processing unit 40 by executing a predetermined program.

That is, the information processing unit 230 includes the reception control unit 31 to the hardware clock 39, and the positional relationship calculation unit 41 to the attitude estimation unit 44.

In the configuration of FIG. 12, the attitude of an object may also be estimated on the basis of a rotational momentum of the object measured by the IMU 110, as in the configuration of FIG. 8.

Even with the above-described configuration, it is possible to realize attitude estimation more suitably.

### 5. Configuration Example of Computer

The above-described series of processing can also be executed by hardware or software. When the series of processing is performed by software, a program for the software is embedded in dedicated hardware to be installed from a program recording medium to a computer or a general-purpose personal computer.

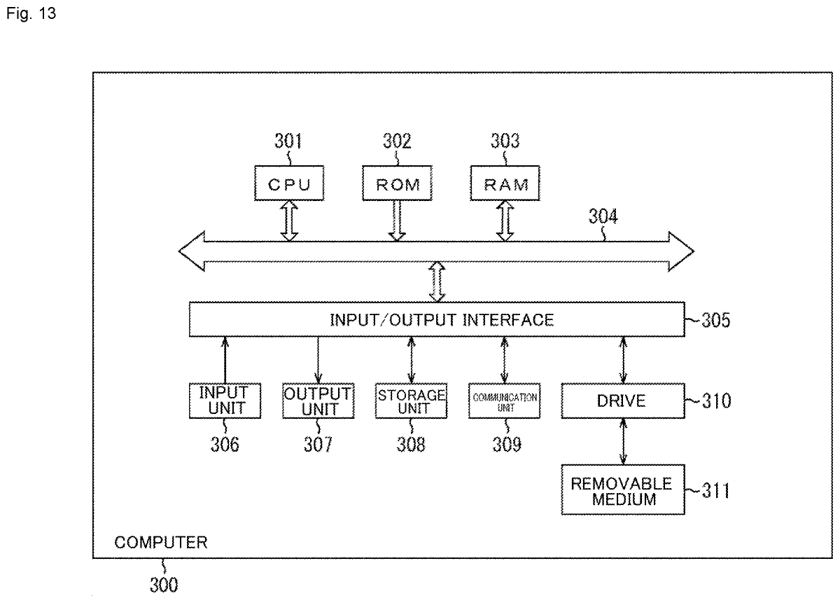

FIG. 13 is a block diagram showing an example of a hardware configuration of a computer that executes a series of processing described above according to a program.

The above-described reception unit 30, information processing unit 40, and information processing unit 230 are realized by a computer 300 having the configuration shown in FIG. 13.

A CPU 301, a ROM 302, and a RAM 303 are connected through a bus 304.

An input/output interface 305 is further connected to the bus 304. An input unit 306 including a keyboard and a mouse and an output unit 307 including a display and a speaker are connected to the input/output interface 305. In addition, a storage unit 308 including a hard disk or a nonvolatile memory, a communication unit 309 including a network interface, a drive 310 driving a removable medium 311 are connected to the input/output interface 305.

In the computer 300 having the above configuration, for example, the CPU 301 performs the above-described series of processing by loading a program stored in the storage unit 308 to the RAM 303 via the input/output interface 305 and the bus 304 and executing the program.

The program executed by the CPU 301 is recorded on, for example, a removable medium 311 or is provided via a wired or wireless transfer medium such as a local area network, the Internet, or a digital broadcast to be installed in the storage unit 308.

The program executed by the computer 300 may be a program that performs processing chronologically in the order described in the present specification or may be a program that performs processing in parallel or at a necessary timing such as a called time.

The embodiments of the present technology are not limited to the above-described embodiments, and various changes can be made without departing from the gist of the present technology.

The advantageous effects described in the present specification are merely exemplary and are not limited, and other advantageous effects may be achieved.

Furthermore, the technology according to the present disclosure can be configured as follows.

(1)

An information processing device including:

a reception control unit configured to control a plurality of antennas such that the antennas switch and receive positioning signals from positioning satellites in a time division manner; and

an attitude estimation unit configured to estimate an attitude of an object on the basis of phase differences between carrier phases of the positioning signals received by the plurality of antennas.

(2)

The information processing device according to (1), further including a phase comparison unit configured to obtain the phase differences by correcting and comparing the carrier phases of the positioning signals on the basis of a time difference in the positioning signals between the antennas.

(3)

The information processing device according to (2), wherein the phase comparison unit calculates the time difference on the basis of time information when the carrier phase of each positioning signal is acquired.

(4)

The information processing device according to (2) or (3), further including a baseline vector gradient calculation unit configured to calculate a gradient of a baseline vector between the antennas on the basis of the phase differences and a positional relationship between the positioning satellites and the object, wherein the attitude estimation unit estimates the attitude of the object on the basis of the gradient of the baseline vector.

(5)

The information processing device according to (4), wherein the attitude estimation unit estimates the attitude of the object in consideration of attitude change based on a rotational momentum of the object.

(6)

The information processing device according to (5), wherein the baseline vector gradient calculation unit calculates the gradient of the baseline vector on the basis of the phase differences, the positional relationship, and the rotational momentum corresponding to the time difference.

(7)

The information processing device according to (5), wherein the attitude estimation unit corrects the estimated attitude of the object on the basis of the rotational momentum corresponding to the time difference.

(8)

The information processing device according to any one of (5) to (7), wherein the rotational momentum is measured by an inertial measurement unit (IMU) mounted on the object.

(9)

The information processing device according to any one of (1) to (8), wherein the reception control unit performs control to switch and receive a plurality of positioning signals on the basis of a phase lock state of the carrier phases of the positioning signals.

(10)

The information processing device according to any one of (1) to (8), wherein the reception control unit performs control to switch and receive a plurality of the positioning signals on the basis of a signal strength of the positioning signals.

(11)

The information processing device according to any one of (1) to (8), wherein the reception control unit performs control to switch and receive a plurality of positioning signals in an order according to a rotation direction of the object.

(12)

The information processing device according to (11), wherein the reception control unit performs control to switch and receive a plurality of positioning signals such that the carrier phases in the rotation direction of the object are compared more frequently.

(13)

The information processing device according to any one of (1) to (12), wherein three or more of antennas are mounted.

(14)

The information processing device according to any one of (1) to (13), wherein the object is an artificial satellite.

(15)

The information processing device according to any one of (1) to (13), wherein the object is a drone.

(16)

An information processing method performed by an information processing device, including;

controlling a plurality of antennas such that the antennas switch and receive positioning signals from positioning satellites in a time division manner; and estimating an attitude of an object on the basis of phase differences between carrier phases of the positioning signals received by the plurality of antennas.

### REFERENCE SIGNS LIST

1 Reception device
10, 10-1 to 10-3 Antenna
20 RF switch
30 Reception unit
31 Reception control unit
32 Down converter
33 A/D converter
34 Despreading processing unit
35 Satellite coordinate acquisition unit
36 Pseudo-distance calculation unit
37 Receiver coordinate calculation unit
38 Carrier phase acquisition unit
39 Hardware clock
40 Information processing unit
41 Positional relationship calculation unit
42 Phase comparison unit
43 Baseline vector gradient calculation unit
44 Attitude estimation unit
110 IMU
230 Information processing unit

1. An information processing device comprising:
a reception control unit configured to control a plurality of antennas such that the antennas switch and receive positioning signals from positioning satellites in a time division manner; and
an attitude estimation unit configured to estimate an attitude of an object on the basis of phase differences between carrier phases of the positioning signals received by the plurality of antennas.

2. The information processing device according to claim 1, further including a phase comparison unit configured to obtain the phase differences by correcting and comparing the carrier phases of the positioning signals on the basis of a time difference in the positioning signals between the antennas.

3. The information processing device according to claim 2, wherein the phase comparison unit calculates the time difference on the basis of time information when the carrier phase of each positioning signal is acquired.

4. The information processing device according to claim 2, further comprising a baseline vector gradient calculation unit configured to calculate a gradient of a baseline vector between the antennas on the basis of the phase differences and a positional relationship between the positioning satellites and the object, wherein the attitude estimation unit estimates the attitude of the object on the basis of the gradient of the baseline vector.

5. The information processing device according to claim 4, wherein the attitude estimation unit estimates the attitude of the object in consideration of attitude change based on a rotational momentum of the object.

6. The information processing device according to claim 5, wherein the baseline vector gradient calculation unit calculates the gradient of the baseline vector on the basis of the phase differences, the positional relationship, and the rotational momentum corresponding to the time difference.

7. The information processing device according to claim 5, wherein the attitude estimation unit corrects the estimated attitude of the object on the basis of the rotational momentum corresponding to the time difference.

8. The information processing device according to claim 5, wherein the rotational momentum is measured by an inertial measurement unit (IMU) mounted on the object.

9. The information processing device according to claim 1, wherein the reception control unit performs control to switch and receive a plurality of positioning signals on the basis of a phase lock state of the carrier phases of the positioning signals.

10. The information processing device according to claim 1, wherein the reception control unit performs control to switch and receive a plurality of the positioning signals on the basis of a signal strength of the positioning signals.

11. The information processing device according to claim 1, wherein the reception control unit performs control to switch and receive a plurality of positioning signals in an order according to a rotation direction of the object.

12. The information processing device according to claim 11, wherein the reception control unit performs control to switch and receive a plurality of positioning signals such that the carrier phases in the rotation direction of the object are compared more frequently.

13. The information processing device according to claim 1, wherein three or more of antennas are mounted.

14. The information processing device according to claim 1, wherein the object is an artificial satellite.

15. The information processing device according to claim 1, wherein the object is a drone.

16. An information processing method performed by an information processing device, comprising:
controlling a plurality of antennas such that the antennas switch and receive positioning signals from positioning satellites in a time division manner; and
estimating an attitude of an object on the basis of phase differences between carrier phases of the positioning signals received by the plurality of antennas.
